(19) United States
(12) Patent Application Publication
(10) Pub. No.: US 2007/0152022 A1
(43) Pub. Date: Jul. 5, 2007

(54) Methods of friction welding in a groove

(76) Inventor: Loren J. Strahm, Florissant, MO (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/324,855

(22) Filed: Jan. 4, 2006

(51) Int. Cl. B23K 31/02; B23K 20/12

(52) U.S. Cl. 228/114; 228/170

(57) ABSTRACT

A method of friction welding in accordance with one embodiment comprises the steps of inserting a protruding portion of one structural member into a groove of another structural member, and then friction welding the two structural members together to form a non-planar weld joint at an interface of the protruding portion of the one structural member and the groove of the other structural member. The groove can be linear or arc-shaped. The friction-welded members may form an acute or right angle.

### BACKGROUND OF THE INVENTION

This invention relates to friction welding and, more specifically, to friction welding of one or more structural members to form a tailored blank or a structural assembly.

Structural devices are often formed as assemblies of a number of smaller structural members. Such assembling of individual members may be necessary to form devices that are too large or too complicated to be formed by conventional manufacturing methods. For example, such factors as casting sizes, forging sizes, available plate and block sizes, and the like can limit the size and geometry of the structural members that can be manufactured. To form larger or more complex devices, the structural members are typically assembled by joining the individual structural members using a variety of known joining techniques including, for example, mechanical fastening or welding.

Joints formed by mechanical fasteners such as rivets, screws, and bolts typically require an overlap of the structural materials at the joint. The fasteners and the overlap of material result in an increase in weight of the joint and the structural assembly. The joint can also introduce areas of increased stress, for example, around holes drilled for receiving rivets. Alternatively, weld joints can be formed to join the structural members, sometimes requiring little or no overlap of material. However, the formation of conventional weld joints, such as by arc or electron beam welding, can result in undesirable dimensional changes in the structural members. Welding can also introduce porosity or other discontinuities into the structural members or otherwise cause unwanted changes to the material properties of the structural members.

Friction welding has also been proposed as an alternative to conventional welding methods for joining members. Linear friction welding, and rotational friction welding can be used to form strong joints without reducing the mechanical characteristics of the joined materials or causing significant dimensional changes. Conventional linear friction welding and rotational friction welding require one member to be moved, i.e. oscillated or rotated, and urged against the other member.

It is known to friction weld structural members together to make a tailored blank that is later machined. Typically the tailored blank approximates the desired dimensions and configuration of the final structural assembly and therefore requires little machining or other subsequent processing to form the final structural assembly.

Making angled intersections is one of the greatest challenges in the fabrication of tailored blanks using friction welding. FIG. 1 illustrates one technique for linear friction welding of two flat plates 2 and 4 to form an angled intersection. In this example, plate 2 has a substantially planar joining face 6 disposed at an acute angle relative to a midplane. Although not shown, the midplane is disposed midway between the mutually parallel faces 8 and 10 of plate 2 (see FIG. 2). During friction welding, a force F is applied on face 12, which is parallel to face 6, and a reaction force R (equal and opposite in direction to applied force F) is exerted on the joining face 6.

This technique, however, generates large forces in the machine as well as the welding block as a result of the out-of-plane loading. To react out the large moment M (indicated by the curved arrow in FIG. 2), the weld feature must be thicker and the welding machine must be significantly stronger. Both of these solutions lead to increased cost and complexity. It is likely this large moment would restrict the force the machine could apply, thereby limiting the size of the structural member that can be welded. This will result in more members being welded, which in turn increases processing cost. In addition, this technique generates a single planar weld face that has poor crack growth properties.

There is a need for improvements in the art of friction welding structural members to form angled intersections in tailored blanks.

### BRIEF DESCRIPTION OF THE INVENTION

The invention is directed to methods of friction welding structural members to make angled intersections. In accordance with the methods of making angled intersections disclosed herein, the overturning moment is either eliminated or reduced to an acceptable level and a non-planar weld joint is produced. This is accomplished by pressing and oscillating a protruding portion of one structural member in a groove of another structural member. The invention is further directed to the resulting welded structures.

One aspect of the invention is a welding method comprising the following steps: (a) inserting a protruding portion of a first structural member into a groove of a second structural member; and (b) friction welding the first and second structural members together to form a non-planar weld joint at an interface of the protruding portion of the first structural member and the groove of the second structural member.

Another aspect of the invention is a welding method comprising the following steps: (a) making a first structural member having a groove; (b) making a second structural member having a protruding portion configured to be received in the groove; (c) placing the protruding portion of the second structural member in contact with the groove of the first structural member; (d) applying force that urges the protruding portion of the second structural member and the groove of the first structural member together in a manner that creates pressure in the area of contact; and (e) alternatingly displacing the first structural member in opposite directions so that the protruding portion moves back and forth in the groove while step (d) is being performed, causing frictional heat to be generated at an interface of the protruding portion of the second structural member and the groove of the first structural member, wherein step (e) is halted after material at the interface becomes plasticized and while step (d) is being performed, step (d) being continued until the plasticized material at the interface forms a non-planar weld.

A further aspect of the invention is a welded structure comprising first and second structural members joined by a non-planar weld joint, the first structural member comprising a protruding portion having surface material that has been plasticized to form a first portion of the weld joint, and the second structural member comprising a groove having surface material that has been plasticized to form a second portion of the weld joint.

Other aspects of the invention are disclosed and claimed below.

### BRIEF DESCRIPTION OF THE DRAWINGS

FIG. 1 is a drawing showing an isometric view of one structural member being joined to another structural member at an acute angle by oscillating the angled member in opposite directions (indicated by a double-headed arrow) while the two members are urged together to create pressure at the interface where the members are in contact.

FIG. 2 is a drawing showing a side view of the setup indicated in FIG. 1. The straight arrows indicate the forces being exerted at the ends of the angled member, while the curved arrow indicates the resulting moment to which the angled member is subjected.

FIG. 3 is a drawing showing an isometric view of one structural member having a protruding portion that is being linear friction welded in a straight groove formed in another structural member in accordance with one method of manufacture. The welded structural members form an acute angle.

FIG. 4 is a drawing showing a side view of the setup indicated in FIG. 3. The straight arrows indicate the forces being exerted at the ends of the angled member.

FIG. 5 is a drawing showing an isometric view of one structural member having a protruding portion that is being linear friction welded in a straight groove formed in another structural member in accordance with another method of manufacture. The welded structural members form a right angle.

FIG. 6 is a drawing showing a side view of the tailored blank resulting from the linear friction welding process depicted in FIG. 5. The bold curved line indicates the weld joint.

FIG. 7 is a drawing showing an end view of the tailored blank depicted in FIG. 6. The hatched areas indicate portions of the tailored blank removed by machining.

FIG. 8 is a drawing showing an end view of the final structural assembly after the machining indicated by hatching in FIG. 7.

FIG. 9 is a drawing showing an isometric view of one structural member having a protruding portion that is being linear friction welded in a straight groove formed in another structural member in accordance with a further method of manufacture. In this implementation, the groove is closed at both ends and the portion protruding into the groove has a length less than the length of the groove.

FIG. 10 is a drawing showing an isometric view of one structural member having a protruding portion that is being rotationally friction welded in an arc-shaped groove formed in another structural member in accordance with yet another method of manufacture.

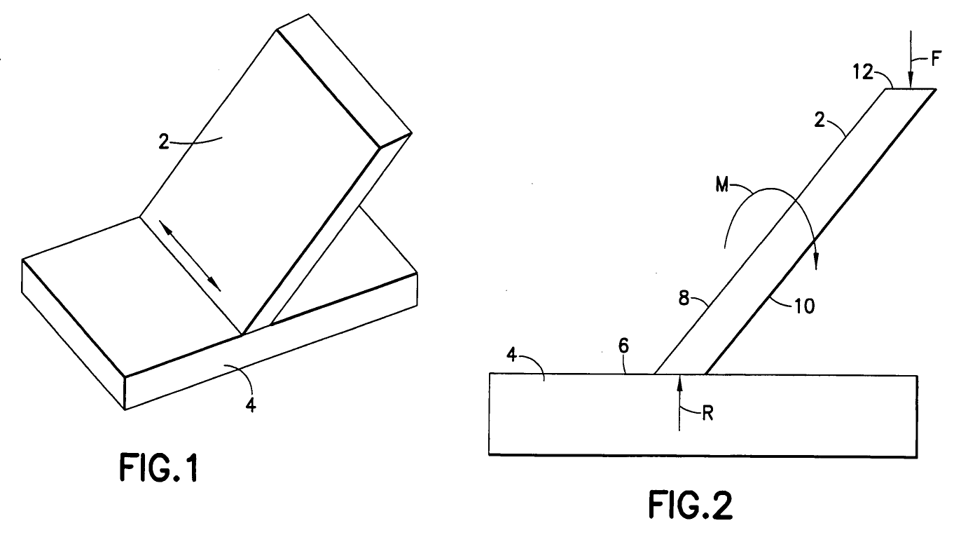

Reference will now be made to the drawings in which similar elements in different drawings bear the same reference numerals.

### DETAILED DESCRIPTION OF THE INVENTION

In a linear friction welding process, respective surfaces of two parts are placed in contact with each other to form an interface and then rubbed together in a reciprocating manner. This is accomplished by moving at least one of the parts back and forth along a line. As the parts are rubbed, compressive force is applied to place the interface under high pressure. At the interface, frictional heat is generated and material from each part plasticizes. Some of this material flows out from between the parts (flash flow), resulting in gradual decrease in the thickness, i.e. the dimension in the direction in which pressure is applied (the dimension normal to the interface) of the parts. When the process is terminated, flash flow ceases, and at the interface, the remaining plasticized material of each part forms a weld, thereby joining the two parts together.

Various methods of linear friction welding structural members to form tailored blanks will now be disclosed. However, it should be appreciated at the outset that these disclosed methods are not limited in their application to the manufacture of tailored blanks. In addition, these methods can be used to join structural members to form a structural assembly that requires no further machining.

Some of the methods of manufacture disclosed herein enable two mutually non-perpendicular structural members to be friction welded together without creating an overturning moment. This is accomplished by making a first structural member having a concave or receiving groove and a second structural member having a convex or protruding portion configured to fit within the aforementioned receiving slot. The groove and protrusion have cross-sectional shapes that are similar in shape, although they need not mate exactly. Both are straight. The protrusion profile may have a variety of shapes, including, but not limited to, multifaceted, V-shaped, circular (i.e., arc-shaped), parabolic, etc. The protruding portion of the second structural feature is pressed into the receiving groove and linear friction welded in place.

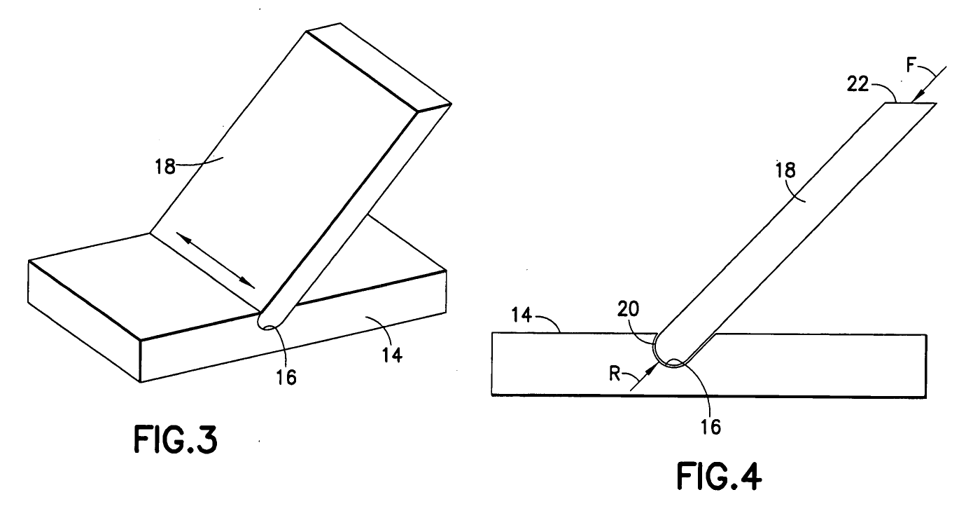

One such arrangement is shown in FIGS. 3 and 4. A plate-shaped structural member 14 is fabricated having substantially mutually parallel top and bottom surfaces and having a groove 16 with edges on the top surface. The groove 16 is straight and has a cross-sectional shape or profile that, in this example, comprises a circular section and a straight section having one end connected tangentially to one end of the circular section and another end connected to the adjoining portion of the top surface of structural member 14. The straight section is inclined at an oblique angle relative to the adjoining portion of the top surface. It should be understood that the groove profile seen in FIG. 4 is substantially constant along the length of the groove 16.

Another plate-shaped structural member 18 is fabricated having substantially mutually parallel top and bottom surfaces and having a protruding portion 20 at one end thereof. The protruding portion in this example has a circular cross-sectional shape or profile that substantially matches the circular portion of the groove profile. Again the profile of the protruding portion is substantially constant along its length. In this example, the circular profile of the protruding portion 20 has a radius slightly less than the radius of the circular portion of the groove profile, which difference in radius allows the protruding portion to be inserted into the groove as seen in FIGS. 3 and 4, with much of the surface of the protruding portion 20 in contact with the surface of the groove. As a result, the structural member 18 is disposed at an acute angle relative to the structural member 14.

The structural member 18 is friction welded to the structural member 14 by applying a force F at the other end 22 of the structural member 18 that is generally parallel to the midplane of the latter, as indicated by arrow F in FIG. 4. The application of force F, coupled with the equal and opposite reactive force R exerted on the protruding portion 20 disposed inside the groove 16, presses the circular surface of protruding portion 20 against the circular portion of the groove surface. While force F is being applied, structural member 18 is moved back and forth relative to the structural member 18 in a repeating pattern at a high frequency. This alternating movement in opposite directions is indicated by the double-headed arrow seen in FIG. 3. The structural member 18 is reciprocated in opposite directions along a line that is parallel to the longitudinal axis of the groove 16.

The structural member 18 can be urged against structural member 14 and reciprocated by an actuator (not shown), such as an electric, hydraulic, or pneumatic actuator that is coupled to and engaged with the structural member 18 by means of a pair of adjustable jaws, clamps, a chuck, or other coupling device (not shown). The structural member 18 can be secured to the clamping device by bolts, tack welding, tooling, or the like. In cases where jaws are employed, each jaw may be provided with a knurled gripping surface for securely gripping the structural member being friction welded. Typically, the structural member 14 is clamped in place and does not move as structural member 18 oscillates. However, the structural members 14 and 18 could be moved in opposite directions. Alternatively, the structural member 14 could oscillate while the structural member 18 is fixed.

In accordance with one exemplary linear friction welding technique, the actuator oscillates the structural member 18 a distance of about 0.1 inch at a rate of about 60 hertz. Alternatively, other oscillation distances and frequencies can be used. The frequency of the reciprocating movement and the applied pressure are selected to cause the materials at the surfaces being rubbed together to plasticize. More specifically, the relative motion between the structural member 24 and the base member 22 generates frictional heating that plasticizes material at the contacting surfaces of the receiving groove 16 and the protruding portion 20. The plasticized material flows under the pressure created by the application of force, so that even in areas of the interface where opposing surfaces of the protruding portion and receiving groove are not in contact under pressure, the surfaces will be welded together by plasticized material that flows into the spec between those confronting areas.

Once sufficient plasticization has occurred, the reciprocating motion of the structural member 18 is terminated. Plasticization can be detected, for example, by mechanical or optical measurements, or friction welding can be continued for a predetermined duration based upon such factors as the type of materials being joined, the size or type of the joint to be formed, and the compressive force therebetween. After the oscillatory motion of the structural member 18 has been terminated, the compressive force between the structural members 14 and 18 inside groove 16 can be maintained by continuing to urge the structural member 18 against the structural member 14 in the direction of force F. As the pressure is maintained, the plasticized material at the interface of the receiving groove 16 and the protruding portion 20 fuses, thereby forming a non-planar weld joint having a profile that roughly approximates the starting profile of the receiving groove. The result of the foregoing process is an angled intersection in which the structural member 18 is disposed at an acute angle relative to the structural member 14.

It should be appreciated that the forces and ranges of motion required for linear friction welding can vary according to such factors as the material of the structural members 14 and 18, the dimensions of the structural members 14 and 18, the surface finishes of the structural members 14 and 18, and the like. For example, in the case where the structural members 14 and 18 are formed of aluminum, the structural member 18 can be urged in direction F with a force sufficient to produce a pressure of about 20,000 psi at the interface inside the receiving groove, while the structural member 18 is reciprocated about 0.1 inch alternatingly in the directions indicated by the double-headed arrow seen in FIG. 3.

As seen in FIG. 4, the applied force F is planar with the centerline of structural member 18. Therefore, the reacting force R is also planar with the centerline of structural member 18. Therefore insignificant or no overturning moment is created. Eliminating the overturning moment decreases the stress within structural member 18 and the stress that the welding machine must react out, leading to a reduction in applied material and machine cost.

In addition to reducing or eliminating the overturning moment, the technique of friction welding in a groove disclosed herein also increases the weld area (i.e., the area of the weld joint) and modifies the weld surface from a single plane. The new weld surface depends on the shape of the protruding and receiving surfaces. If the crack growth properties of the welded material are less than the crack growth properties of the parent material, cracks will tend to propagate through the weld surface. Since cracks tend to grow perpendicular to the local stress field, they tend to propagate in a linear fashion. If the weld surface is non-planar, some portion thereof is not perpendicular to the local stress field. Therefore, although a crack may still be initiated, the crack will not propagate through the weld as easily when the weld surface is non-planar.

The foregoing crack growth resistance properties of a non-planar weld joint make it advantageous to use the technique of friction welding in a groove to form intersections that are not angled, i.e., in situations wherein overturning moment is not a concern, such as when the intersecting structural members are at right angles relative to each other.

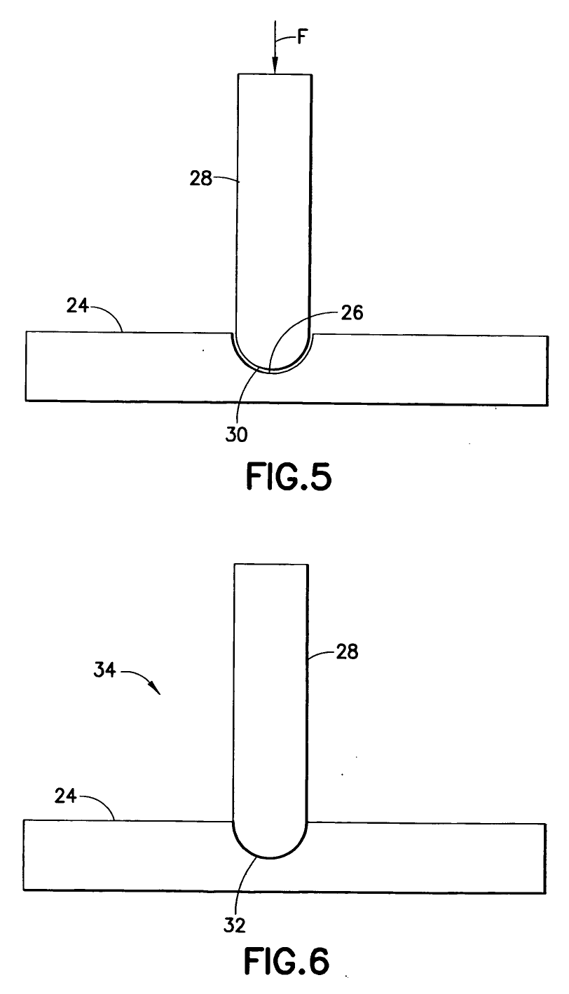

A method for making a T-shaped (right-angled) intersection using friction welding in a groove is shown in FIGS. 5 and 6. FIG. 5 shows one structural member 28 having a protruding portion 30 that is being linear friction welded in a straight groove 26 formed in another structural member 24. The welded structural members 24 and 28 form a right angle. The profiles of the receiving groove 26 and the protruding portion 30 in this example are mutually concentric circular arcs of slightly different radius. However, as previously mentioned, other shapes, such as multifaceted, parabolic, etc., can be used. For the purpose of illustration, the receiving groove 26 and the protruding portion 30 have been depicted with a small gap therebetween, while in reality the surface of the protruding portion of structural member 28 will be in contact with the groove surface.

The structural members 24 and 28 are welded in groove 26 by applying a force F that presses the protruding end 30 of structural member 28 against the groove surface and then oscillating the member 28 (into and out of the sheet) while member 24 is held fixed. The applied pressure and the frequency and duration of the oscillations are selected such that the materials at the surfaces of the protruding end 30 of structural member 28 and of groove 26 of structural member 24 plasticize. When the degree of plasticization is sufficient, the oscillatory motion is terminated. The plasticized material then cools and hardens while force F continues to be applied, forming a non-planar weld joint 32 (shown in FIG. 6) where the interface between the contacting surfaces of the protruding end 30 and the receiving groove 26 previously was. The result is a T-shaped intersection 34 having a non-planar weld joint 32 that is less conducive to crack propagation.

The T-shaped intersection 34 may constitute a tailored blank by itself or may be friction welded to further structural members to form a larger and more complex tailored blank. In either case, the T-shaped intersection 34 can then be machined or otherwise trimmed or processed to the dimensions of the desired finished structural assembly. The T-shaped intersection 34 can be trimmed by any known means, including using a manual or computer-guided machining device, such as a computer numeric control (CNC) machine (not shown in the drawings).

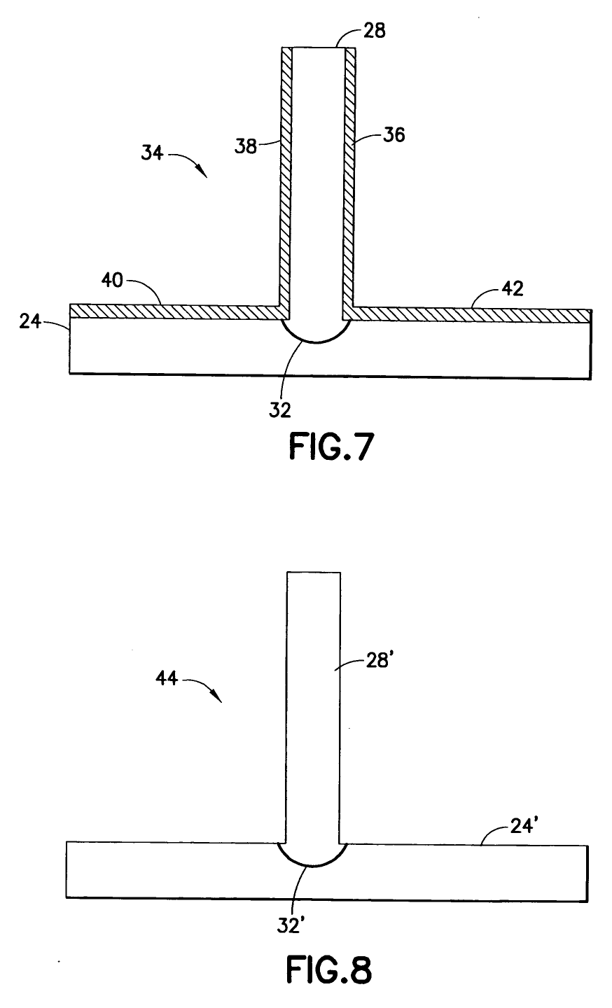

During machining, portions of the structural members 24 and 28 can be removed. The hatched regions 36 and 38 in FIG. 7 represent material removed from the structural member 28, while the hatched regions 40 and 42 represent material removed from the structural member 24. Although not shown in FIG. 7, flash produced during the friction welding operations can also be removed by this trimming operation. An end view of the final structural assembly 44 having a flange portion 28′ joined to a web portion 24′ by means of a non-planar weld joint 32′ is shown in FIG. 8.

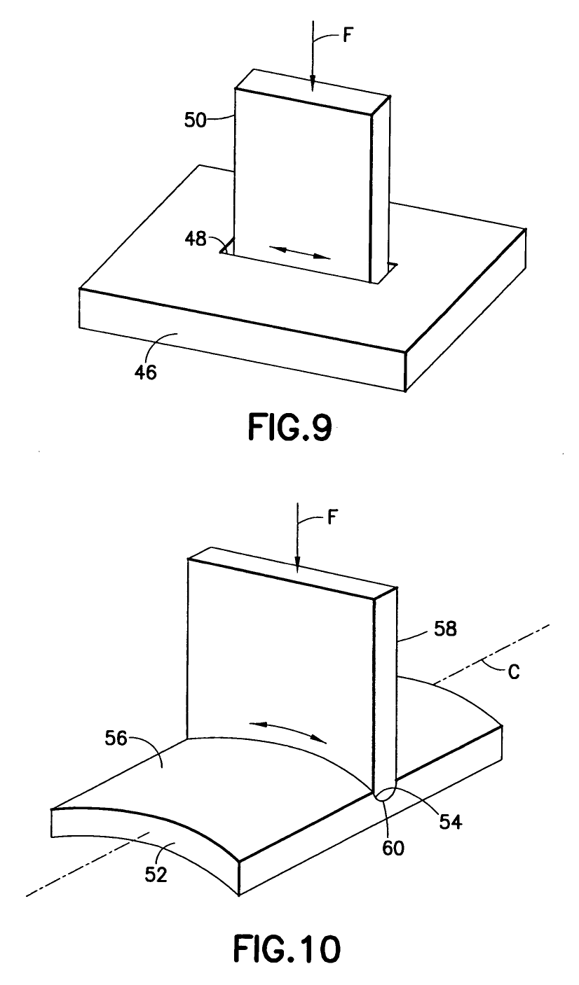

FIG. 3 showed an example wherein the widths of the structural members 1 and 18 were the same, so that the receiving groove 16 extended the full width of structural member 14. In cases where the structural member being inserted into the groove has a width less than the width of the grooved structural member, then the groove need not extend the full width of the latter, but rather need only be slightly longer than the protruding portion inserted therein. One example of such a construction is shown in FIG. 9. One structural member 50 is shown with its protruding portion inserted into a straight groove 48 formed in another structural member 46. The groove 48 is closed at both ends and the portion protruding into the groove has a length less than the length of the groove. The protruding portion of structural member 50 can be friction welded in the groove 48 by applying a force F that pushes the surface of the protruding portion against the surface of the groove and then causing the structural member 50 to oscillate along the longitudinal axis of the groove, as indicated by the double-headed arrow. While FIG. 9 depicts the case wherein the structural members 46 and 50 are at right angles, a groove with closed ends can also be used when the structural members form an acute angle.

In accordance with a further method of manufacture, the protruding portion and the receiving groove of the respective members to be welded may be arc-shaped instead of straight, in which case the oscillatory motion will be rotational instead of linear. An example of such a configuration is shown in FIG. 10. Item 52 is a circular cylindrical (hereinafter “curved”) plate having a centerline C and constant thickness (measured in the vertical direction). An arc-shaped groove 54 is formed in curved plate 52 and has a semicircular cross-sectional profile. Item 58 is a planar plate having an arc-shaped protruding portion 60 that is disposed in the receiving groove 54. The protruding portion 60 also has a semicircular cross-sectional profile. Also the radii of curvature of the receiving groove and the protruding portion are equal. A downwardly directed force F is applied at the top of the structural member 58, which presses the surface of protruding portion 60 against the surface of receiving groove 54. While force F is being applied, the structural member 58 is oscillated back and forth along the arc of groove 54, as indicated by the double-headed curved arrow in FIG. 10. Although the length of the oscillatory motion along the arc of the groove may be only about 0.1 inch, the member 58 is in fact being rotated back and forth about a center of rotation, the angle of rotation being extremely small. The friction inside the groove during this oscillatory rotation causes material at the interface of the protruding portion and the receiving groove to plasticize. After sufficient plasticization has occurred, the oscillatory rotation is terminated while continuing to apply force F. Then the plasticized material cools and forms a weld joint (not shown in FIG. 10) having a shape that approximates the inner half of a sector of a torus. While a groove having a semicircular profile has been disclosed, the groove may have other cross-sectional shapes, e.g., multifaceted, parabolic, etc.

For the purpose of illustration, embodiments has been disclosed in which the structural members are plates. However, structural members other than plates can also be joined using the technique of friction welding in a groove.

Tailored blanks can be formed from any number of structural members depending on the desired dimensions and configuration of the final structural assembly. Further, the configuration and material composition of the structural members can be selected according to the specifications and design requirements of the final structural assembly. Advantageously, by constructing tailored blanks having dimensions and configurations closely or substantially approximating the predetermined dimensions and configuration of the corresponding desired final structural assembly, machining time and material waste can be minimized, making the finished structural assemblies more economical to produce.

Advantageously, each of the structural members can be standard stock items in inventory. As is known in the art, the structural members can be formed from a variety of fabricating processes such as milling, casting, die or hand forging, extruding, rolling, and machining. The structural members can be formed from materials having high strength-to-weight ratios and good corrosion resistance. For purposes of example only and not limitation, the structural members may comprise aluminum, aluminum alloys, titanium, titanium alloys, steel, nickel-based alloys, copper-based alloys, beryllium-based alloys, or mixtures thereof. Further, the structural members can be formed from similar or dissimilar materials (provided that the dissimilar materials are of types that can be welded together).

The methods of linear friction welding disclosed herein are not limited in their application to the manufacture of tailored blanks. In addition, these methods can be used to join structural members to form a structural assembly that requires no further machining. For example, the hub of a rotor may be provided with a plurality of mutually parallel grooves on a circumferential surface, spaced at equiangular intervals. One end of a respective finished rotor blade can be inserted in each groove and then friction welded in place.

The finished structural assemblies manufactured by the methods disclosed herein can be used as structural components of a vehicle, such as an aircraft, an automobile, or a marine craft. For example, a multiplicity of the structural assemblies can be joined to form a wing, wing support structure, fuselage, and the like of an airplane. Alternatively, the structural assemblies can be used in buildings, machinery, and the like.

Many modifications and other embodiments of the invention will come to mind to one skilled in the art to which this invention pertains having the benefit of the teachings presented in the foregoing descriptions and the associated drawings. For example, the structural members can be processed before and/or after joining by friction welding. Such processing can include cleaning the joining surfaces of the structural members to remove oxidation or surface defects. Additionally, the structural members can be heat treated by aging, quenching, stretching, annealing, or solution annealing to obtain desired mechanical or chemical properties, as is known in the art. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

While the invention has been described with reference to various embodiments, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

1. A welding method comprising the following steps:
(a) inserting a protruding portion of a first structural member into a groove of a second structural member; and
(b) friction welding said first and second structural members together to form a non-planar weld joint at an interface of said protruding portion of said first structural member and said groove of said second structural member.

2. The method as recited in claim 1, wherein said groove is straight.

3. The method as recited in claim 1, wherein said groove is arc-shaped.

4. The method as recited in claim 1, wherein said groove has a cross-sectional shape comprising a curved portion.

5. The method as recited in claim 4, wherein said cross-sectional shape of said groove further comprises a straight portion.

6. The method as recited in claim 4, wherein said curved portion of said groove is circular, parabolic or elliptical.

7. The method as recited in claim 1, wherein said groove has a V-shaped cross section.

8. The method as recited in claim 1, wherein said groove has a cross-sectional shape comprising first and second straight portions that intersect at a vertex.

9. The method as recited in claim 2, wherein said first and second structural members are flat plates that form an acute angle or a right angle when welded together.

10. The method as recited in claim 3, wherein said first structural member is a flat plate and said second structural member is a circular cylindrical plate.

11. A welding method comprising the following steps:
(a) making a first structural member having a groove;
(b) making a second structural member having a protruding portion configured to be received in said groove;
(c) placing said protruding portion of said second structural member in contact with said groove of said first structural member;
(d) applying force that urges said protruding portion of said second structural member and said groove of said first structural member together in a manner that creates pressure in the area of contact; and
(e) alternatingly displacing said first structural member in opposite directions so that said protruding portion moves back and forth in said groove while step (d) is being performed, causing frictional heat to be generated at an interface of said protruding portion of said second structural member and said groove of said first structural member,
wherein step (e) is halted after material at said interface becomes plasticized and while step (d) is being performed, step (d) being continued until the plasticized material at the interface forms a non-planar weld.

12. The method as recited in claim 11, wherein said groove is straight.

13. The method as recited in claim 11, wherein said groove is arc-shaped.

14. The method as recited in claim 11, wherein said groove has a cross-sectional shape comprising a curved portion.

15. The method as recited in claim 11, wherein said groove has a cross-sectional shape comprising a straight portion.

16. The method as recited in claim 11, wherein said first and second structural members are plates that form an acute or right angle when welded together.

17. The method as recited in claim 11, wherein said groove is closed at both ends and said protruding portion has a length less than the length of said groove.

18. A welded structure comprising first and second structural members joined by a non-planar weld joint, said first structural member comprising a protruding portion having surface material that has been plasticized to form a first portion of said weld joint, and said second structural member comprising a groove having surface material that has been plasticized to form a second portion of said weld joint.

19. The welded structure recited in claim 18, wherein said groove was straight.

20. The welded structure as recited in claim 18, wherein said groove was arc-shaped.
